(19) United States
(12) Patent Application Publication
(10) Pub. No.: US 2008/0186895 A1
(43) Pub. Date: Aug. 7, 2008

(54) Communication Method And Apparatus For Providing Real-Time Wireless Bulletin Board System

(75) Inventors: Dan Shang, Shanghai (CN); Li Sun, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/813,593

(22) PCT Filed: Jan. 12, 2005
(86) PCT No.: PCT/IB06/50066

§ 371 Date: Jul. 10, 2007

(30) Foreign Application Priority Data
Jan. 12, 2005 (CN) 200510003922.9

(51) Int. Cl. H04H 20/71

(52) U.S. Cl. 370/312

(57) ABSTRACT

The present invention provides a communication method executing by a network system, comprising the steps of: receiving a request for establishing a real-time wireless BBS (Bulletin Board Service) from a UE supporting P2P (Peer-to-Peer) communication mode among a group of UEs (User Equipments), wherein the request includes identification information of other UEs among the group of UEs; allocating corresponding radio resources to the group of UEs according to the request for establishing the real-time wireless BBS, so that information can be exchanged via direct links among UEs that supporting P2P communication mode.

### FIELD OF THE INVENTION

The present invention relates to a communication method and apparatus, and, more particularly, to a communication method and apparatus for providing RWBBS (Real-time Wireless Bulletin Board System) in communication networks supporting P2P (Peer-to-Peer) communication mode.

### BACKGROUND OF THE INVENTION

BBS (Bulletin Board Service) is an electronic information service system on Internet. When a User Equipment (UE) issues information via BBS, the information it sends is firstly delivered to a server that has configured the BBS. Through accessing the server, all online users of the BBS can acquire the information the UE issues. The birth of BBS on Internet provides a convenient information interaction approach. Each online BBS user can exchange or share messages and files posted by any UE on the network.

However, typically every user may achieve information or file sharing via fixed and complex hardware facilities, such as computers for logging into Internet, cables for network inter-connecting and so on. When a user is traveling, it's very likely that information can't be acquired duly via BBS due to lack of network support. Furthermore, it's very inconvenient for the user to bring computer and similar hardware facilities (even portable computer). In addition, when some mutually acquainted people go to the same scenic spot, if they can exchange or share local touring information, like weather, traffic, customs and so on, in a way similar to BBS without needing complex computers and fixed networks, undoubtedly it will bring more convenience and pleasure to them.

With the development of wireless communication techniques, users can obtain various information services, like voice, text, image and so on, easily and rapidly, from the wireless communication network, for example, by mobile terminals. It's becoming a hot research topic in the fields of current wireless communication techniques, to enable information sharing or exchange among all users of the mobile terminals through a wireless communication network with broad coverage so that the wireless communication network can provide a real-time wireless BBS (RWBBS).

But in practical applications, when users of the mobile terminals use RWBSS, it will consume more radio resources if every user posts or acquires information via the network system (for example, UTRAN, Universal Terrestrial Radio Access Network of the 3^{rd} mobile communication network TD-SCDMA). Additionally, frequent information interaction via the network system will cause more wireless interference to the communication network and thus affect the network capacity.

It is, therefore, necessary to put forward a new communication method and apparatus adapted to information sharing among users in a wireless communication network.

### OBJECT AND SUMMARY OF THE INVENTION

An object of the present invention is to provide a communication method and apparatus for enabling a wireless communication network to provide real-time wireless BBS (RWBBS), with which UEs not only can share information duly, but also can save radio resources of the network, decrease wireless interference and further increase network capacity, when they are very close to each other.

To fulfill the above object of the present invention, there is provided with a communication method to be executed by a network system in accordance with the present invention, comprising the steps of: receiving a request for establishing a real-time wireless BBS from a UE supporting P2P communication mode among a group of UEs, wherein the request includes identification information of other UEs among the group of UEs; allocating corresponding radio resources to the group of UEs according to the request for establishing the real-time wireless BBS, so that information can be exchanged via direct links among UEs supporting P2P communication mode.

There is provided with a communication method to be executed by a UE supporting P2P communication mode in accordance with the present invention, comprising the steps of: sending a request to a network system for establishing a real-time wireless BBS among a group of UEs including the UE, wherein the request includes identification information of other UEs among the group of UEs; receiving radio resources allocated according to the request from the network system; exchanging information with the other UEs via direct links for P2P communication, by using the radio resources.

There is provided with a communication method for a wireless communication network supporting P2P (Peer-to-Peer) communication mode to be executed by a UE (User Equipment) in accordance with the present invention, comprising the steps of: receiving a paging message, which is sent out according to a request for establishing a real-time wireless BBS among a group of UEs from a network system; sending a paging response message to the network system, wherein the paging response message comprises at least one of location information of the UE, P2P capability indication information and information about whether establishment of the real-time wireless BBS is allowed or not.

A network system is provided in accordance with the present invention, comprising: a receiving unit, for receiving a request for establishing a real-time wireless BBS from a UE supporting P2P communication mode among a group of UEs, wherein the request includes identification information of other UEs among the group of UEs; a determining unit, for determining whether requirements for establishing the real-time wireless BBS among the group of UEs are satisfied or not; an allocating unit, for allocating corresponding radio resources to the group of UEs if the requirements for establishing the real-time wireless BBS are satisfied so that information can be exchanged via direct links among UEs supporting P2P communication mode among the group of UEs.

A UE supporting P2P communication mode is provided in accordance with the present invention, comprising: a transmitting unit, for sending a request to a network system for establishing a real-time wireless BBS among a group of UEs including the UE, wherein the request includes identification information of other UEs among the group of UEs; a receiving unit, for receiving radio resources allocated according to the request from the network system; a communicating unit, for exchanging information with the other UEs via the direct links for P2P communication, by using the radio resources.

The above and other objects, features and other advantages of the present invention will be more clearly understood from the following detailed description taken in conjunction with the accompanying drawings.

### BRIEF DESCRIPTION OF THE DRAWINGS

For a detailed description of the preferred embodiments of the invention, reference will now be made to the accompanying drawings in which:

FIG. 1 shows a schematic diagram in which UEs share a RWBBS in a wireless communication network in accordance with an embodiment of the present invention;

FIG. 2 is a flowchart of the method for implementing RWBBS in accordance with an embodiment of the present invention;

FIG. 3 is a flowchart of the method for a UE to join RWBBS in accordance with an embodiment of the present invention; and

FIG. 4 is a flowchart of the method for a UE to quit RWBBS in accordance with an embodiment of the present invention.

Throughout the drawings, the same or similar elements are denoted by the same reference numerals.

### DETAILED DESCRIPTION OF THE INVENTION

With regard to a communication method capable of providing real-time wireless BBS as proposed according to the present invention, when a group of UEs wanting to exchange information in real time are very close to each other, if these UEs have P2P communication capability, by referring to P2P communication mode, the group of UEs can exchange traffic information by establishing P2P direct links among these UEs with the help of the network system. In such RWBBS communication mode, since traffic signals are transferred directly among the UEs without establishing dedicated channels for transferring traffic signals between the base station and the UEs, this communication method can thus save radio resources very effectively.

Detailed descriptions of the P2P communication mode and the specific procedure for transferring traffic signals via P2P direct links are disclosed in the patent applications serial No. CN03119892.9 and CN03119894.5, filed by KONINKLIJKE PHILIPS ELECTRONICS N.V. on Mar. 7, 2003, which are incorporated herein by reference.

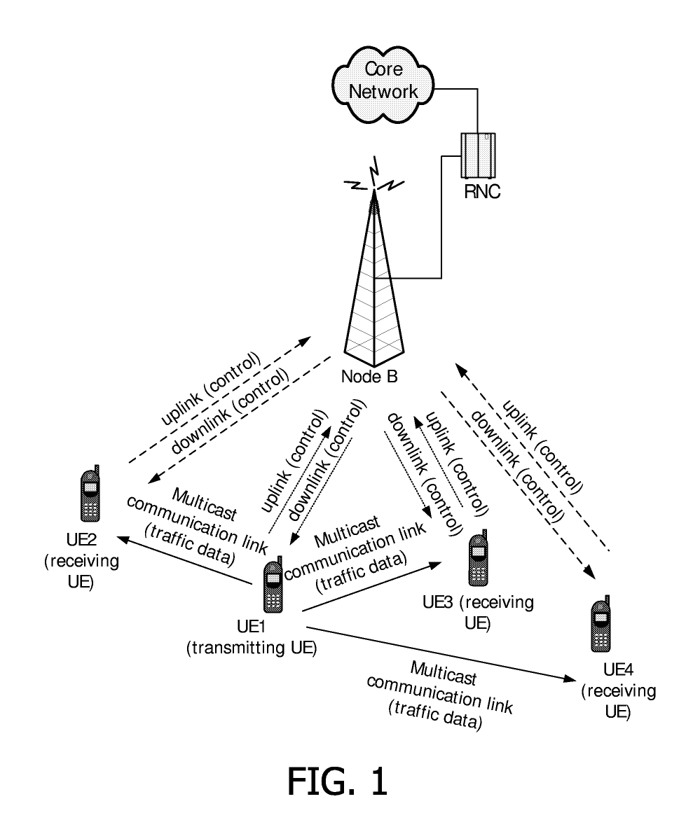

FIG. 1 is a schematic diagram in which UEs share RWBBS in a wireless communication network in accordance with an embodiment of the present invention. As shown in FIG. 1, by referring P2P communication mode, UE1, UE2, UE3 and UE4 maintain signaling links with UTRAN respectively, so that UTRAN still holds control over each UE in RWBBS communication mode. Moreover, direct links for P2P communication are established respectively among UE1 as the transmitting UE and multiple UEs, UE2, UE3 and UE4, as the receiving UE.

In RWBBS communication mode as shown in FIG. 1, UE1 transmits traffic data via each direct link simultaneously, by using the same radio resources allocated by UTRAN, i.e., the same frequency carrier in the same timeslot and the same spreading code. UE2, UE3 and UE4 at the receiving side, receive the traffic data in the same timeslot from UE1 via their respective direct link with UE1, by using the corresponding radio resources allocated by UTRAN.

Since UE1 can send traffic data to UE2, UE3 and UE4 via respective direct link and information sharing can be realized with no need to establish traffic link between each UE and UTRAN, the method for providing RWBBS of the present invention as shown in FIG. 1 can save radio resources greatly. Additionally, signaling links are maintained between UTRAN and each of UE1, UE2, UE3 and UE4 all through, so UTRAN can monitor the ongoing RWBBS communication in real time.

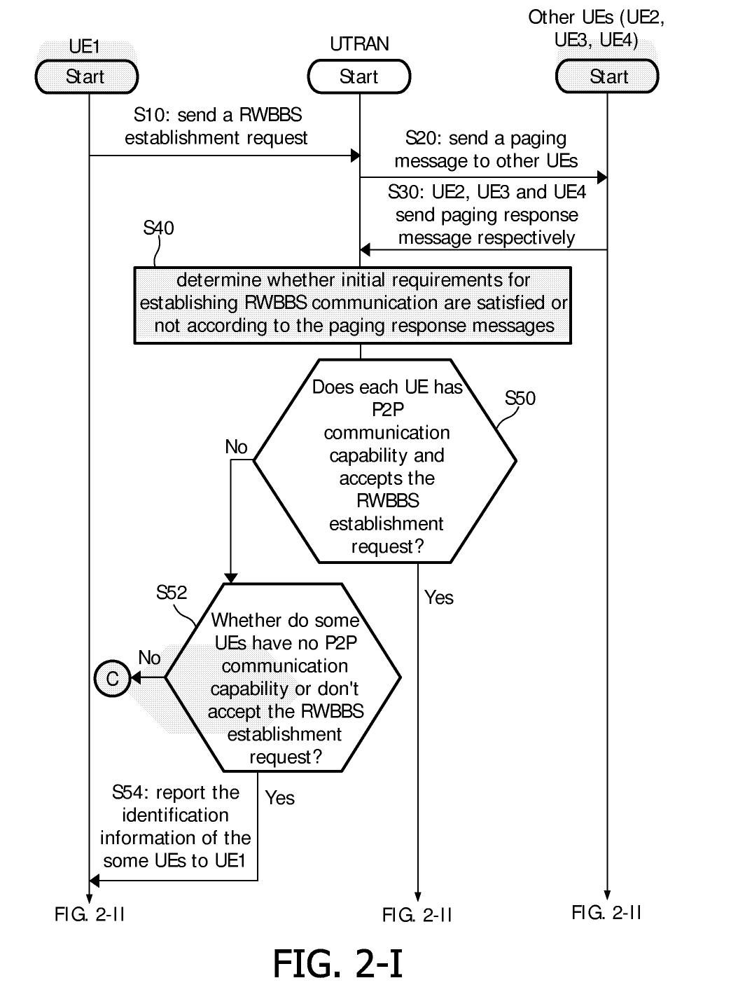

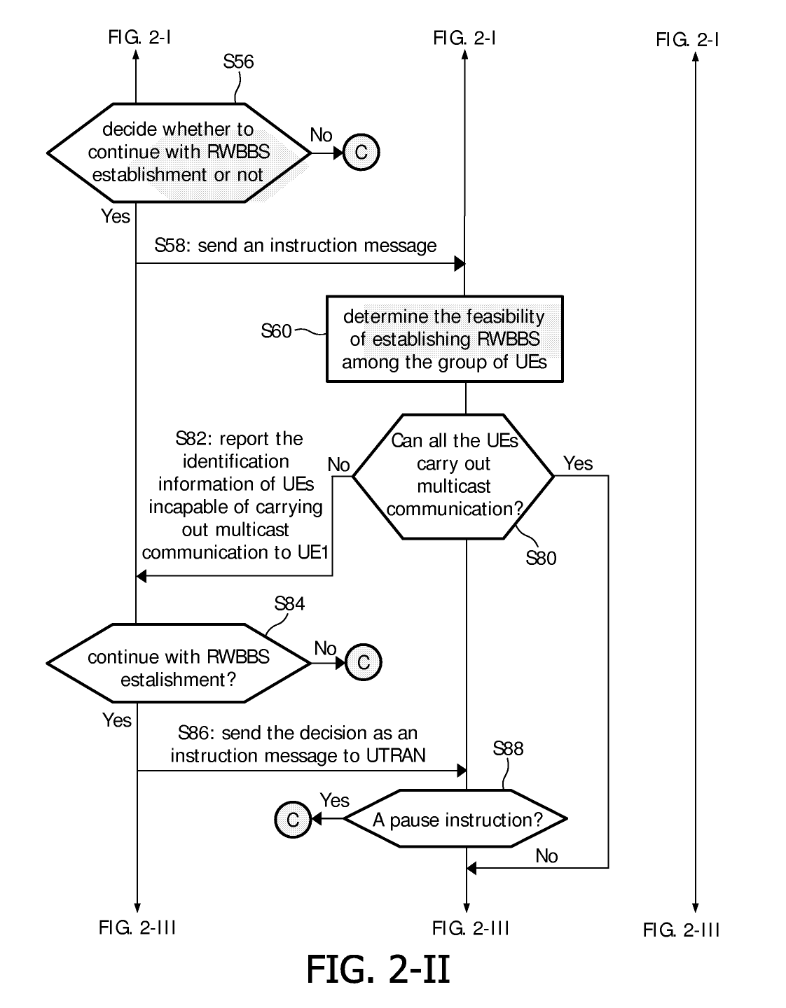

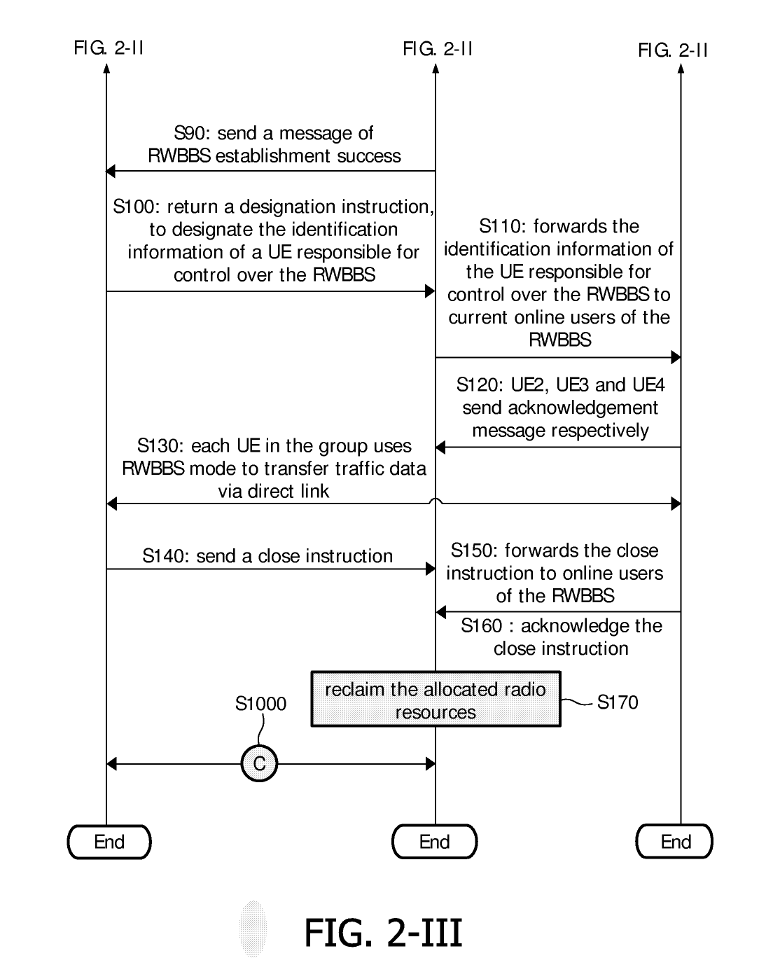

Descriptions will be given below to the flowchart of the method for implementing RWBBS according to an embodiment of the present invention, in conjunction with FIG. 2, taking TD-SCDMA system as an example.

It's assumed that UE1 having P2P communication capability can initiate establishment of RWBBS communication mode. As shown in FIG. 2, when UE1 in idle status attempts to adopt RWBBS communication mode to exchange information with a group of UEs within the same cell, UE1 sends a RWBBS establishment request to the network system UTRAN, so as to start a random access process (step S10).

The RWBBS establishment request comprises user identification information of other UEs (like UE2, UE3 and UE4) among the group of UEs. The user Identification information may be the telephone number of the user, or other information that can identify the user's identity.

Upon receipt of the RWBBS establishment request, UTRAN sends a paging message to UE2, UE3 and UE4 respectively according to the Identification information of other UEs, to notify the other UEs of the message that UE1 initiates a RWBBS establishment (step S20).

Assuming that the other UEs are in idle status at that time, UE2, UE3 and UE4 send paging response messages to UTRAN respectively after receiving the paging message, and enter connected status respectively (step S30).

Though the paging response message, each UE (i.e. UE2, UE3 and UE4) notifies UTRAN of whether or not it has RWBBS capability to exchange information in RWBBS mode, along with information about whether it accepts UE1's RWBBS establishment request or not. A UE supporting P2P communication generally has the capability of carrying out RWBBS communication.

Further, UTRAN can obtain the location information of each UE according to the paging response message. The location information can be information for estimating the location of the UE, such as Direction of Arrival (DOA) of the paging response signal, the time at which the paging response signal reaches the base station and etc. UTRAN also can use Global Positioning System (GPS) to obtain the specific location of the UE. Since the UTRAN can obtain the UE's location in a conventional way, a detailed description is omitted here.

On receipt of the paging response messages from UE1, UE2 and UE3, UTRAN determines whether or not the group of UEs comprising UE1, UE2, UE3 and UE4 satisfy the predefined initial requirement for establishing RWBBS communication, according to these paging response messages (step S40).

UTRAN first judges whether UE2, UE3 and UE4 all support RWBBS communication or not, i.e. whether UE2, UE3 and UE4 all have P2P communication capability or not, according to the RWBBS capability indication information included in the paging response messages. Then, UTRAN judges whether or not UE2, UE3 and UE4 all agree to establish RWBBS with UE1 according to information about whether the RWBBS establishment request is accepted or not included in the paging response messages.

UTRAN determines whether or not RWBBS can be established between UE1 and UE2, UE3 and UE4 according to the above two judgment results (step S50).

(1) If each UE has P2P communication capability and accepts the RWBBS establishment request, the predetermined initial requirement for establishing RWBBS communication is satisfied, and thus UTRAN continues with subsequent operation step S60 for establishing RWBBS.

(2) If some UEs (such as UE2) have no P2P communication capability or some UEs (such as UE2) don't accept the RWBBS establishment request (step S52), UTRAN reports the identification information about the some UEs (such as UE2) to UE1 (step S54).

On receipt of the Identification information of the some UEs not satisfying the initial requirement, UE1 will determine whether or not to continue RWBBS establishment with other UEs satisfying the initial requirement in the case of absence of the some UEs, according to actual conditions (step S56).

For example, if user of UE2 is the leader of the group of users, the information exchanged among the group of users should be known by the user of UE2. Thus, UE1 will instruct to pause this RWBBS establishment procedure; on the other hand, if UE2 is just an ordinary member, UE1 will possibly instruct to continue with RWBBS establishment.

UE1 sends its decision as an instruction to UTRAN (step S58). On receipt of a pause instruction, UTRAN will perform operations to end this RWBBS establishment (step S1000); conversely, on receipt of a go-on instruction, UTRAN will perform subsequent operation step S60 for establishing RWBBS.

(3) If none of the UEs has P2P communication capability or none of the UEs accepts the RWBBS establishment request, UTRAN will perform operations to end this RWBBS establishment (step S1000).

If it's determined to continue with subsequent operations for establishing RWBBS including the above two cases of (1) and (2), UTRAN determines whether or not multicast communication can be carried out among the group of UEs, for example, UE1, UE2, UE3 and UE4 in case (1) and UE1, UE3 and UE4 in case (2), i.e.: further determines the feasibility of establishing RWBBS among the group of UEs (step S60).

UTRAN judges whether the distance between any two UEs of the group of UEs satisfying the initial requirement is within the wireless coverage range for P2P communication or not, according to the UE's location information included in the paging response message. Next, UTRAN allocates radio resources for P2P link probing to the group of UEs. Each UE respectively uses the radio resources to send probing signals sequentially (in order) to other UEs in the group according to the P2P link probing procedure in multicast communication, i.e.: performs P2P probing procedure for direct link; UTRAN receives the probing report from each UE, and judges whether the performance of the direct link between any two UEs of the group of UEs can satisfy the QoS requirement for traffic communication or not according to the probing result from each UE, so as to further determine whether the predefined requirement for establishing RWBBS between the group of UEs is satisfied or not.

As to the P2P direct link probing procedure to be performed by the UE in multicast communication, specific steps are described in the patent application entitled “Method and Apparatus for Multicast Communication in Wireless Communication Networks”, filed by KONINKLIJKE PHILIPS ELECTRONICS N.V. along with the present application, Attorney's Docket No. CNPHI0087 (CN050011), which is incorporated herein by reference.

Based on the above two judgment results, UTRAN will further determine whether or not RWBBS can be established among the group of UEs satisfying the above initial requirement.

(1) If each UE is within the wireless coverage range for P2P communication of any of other UEs in the group and the probing result shows that the direct links between any two UEs can be used for transferring traffic signals, i.e. all P2P link probing succeeds (step S80), UTRAN will perform subsequent operation step S90 for establishing RWBBS.

(2) If the distance between some UEs (such as UE2) and other UEs (such as UE3) in the group is beyond the wireless coverage range for P2P communication or the probing result shows that the direct links between some UEs (such as UE2) and other UEs (such as UE3) in the group can't be used for transferring traffic signals, i.e. some P2P link probing fails, UTRAN reports the identification information of the some UEs (such as UE2) and the involved UEs (such as UE3) to UE1 (step S82).

On receipt of the Identification information of these unqualified UEs, UE1 judges whether to continue with RWBBS establishment or not in the case of absence of the some UEs, according to actual conditions (step S84), and sends the decision as an instruction message to UTRAN (step S86).

UTRAN performs corresponding operations according to the received instruction message (step S88). If a pause instruction is received, UTRAN will stop the operation for establishing RWBBS (step S1000); if a go-on instruction is received, UTRAN will perform the subsequent operation step S90 for establishing RWBBS.

At step S90, UTRAN sends a RWBBS establishment success message to UE1, the initiator of RWBBS establishment, and requests UE1 to further indicate the identification information of the UE responsible for control over the RWBBS (step S90). The UE responsible for control over the RWBBS functions as the board manager (master) of BBS on Internet.

On receipt of the request message sent from UTRAN, UE1 returns a designation instruction to UTRAN, the instruction including the Identification information of the UE responsible for control over the RWBBS and designated by UE1. Of course, the instruction can also comprise the name of the RWBBS named by UE1, to be used when UEs in the group logs into the RWBBS (step S100).

It's assumed that UE1 designates itself to be responsible for control over the RWBBS and UTRAN determines through the above determination procedure that RWBBS can be established among the group of UEs comprising UE1, UE2, UE3 and UE4, then, on receiving the above designation instruction, UTRAN forwards the Identification information of UE1 and the name of the RWBBS to current online users of the RWBBS, i.e. UE2, UE3 and UE4 currently sharing the RWBBS (step S110).

On receipt of the information about the board manager and the name of the RWBBS forwarded by UTRAN, UE2, UE3 and UE4 send a receipt acknowledgment message to UTRAN (step S120).

Through the above procedure, RWBBS is established among a group of UEs (such as UE1, UE2, UE3 and UE4), with the help of UTRAN. The owner of each UE can exchange information in real time with others through the RWBBS.

After RWBBS establishment, when the user of a certain UE expects to share some information with other members in the group, the UE can send the traffic data via the direct links between the UE and other UEs in the group by using the radio resources for multicast communication allocated by the network system, in multicast communication manner such as described in the patent application filed by KONINKLIJKE PHILIPS ELECTRONICS N.V. along with the present application, Attorney's Docket No. CNPHI0087 (step S130). In this case, the UE wanting to share information acts as the transmitting UE in multicast communication and other UEs in the group act as the receiving UEs in multicast communication, which is incorporated herein by reference.

When the UE (for example, UE1 in the present embodiment) responsible for control over the RWBBS attempts to close the RWBBS, UE1 sends a close instruction to UTRAN and releases the radio resources occupied (step S140).

On receipt of the close instruction, UTRAN forwards the close instruction to the current online users of the RWBBS, for example, UE2, UE3 and UE4 (step S150).

On receipt of the forwarded close instruction, UE2, UE3 and UE4 send a receipt acknowledgement message to UTRAN and release the radio resources occupied (step S160).

After determining that UE2, UE3 and UE4 have received the forwarded close instruction, UTRAN reclaims the radio resources allocated (step S170).

The above description is given to the procedure of implementing RWBBS in wireless communication networks in accordance with an embodiment of the present invention in conjunction with FIG. 2. Descriptions will now be made to the procedure for another UE (UE5) to join the RWBBS after the RWBBS is established among UE1, UE2, UE3 and UE4 through the above procedure, with reference to another embodiment of the present invention.

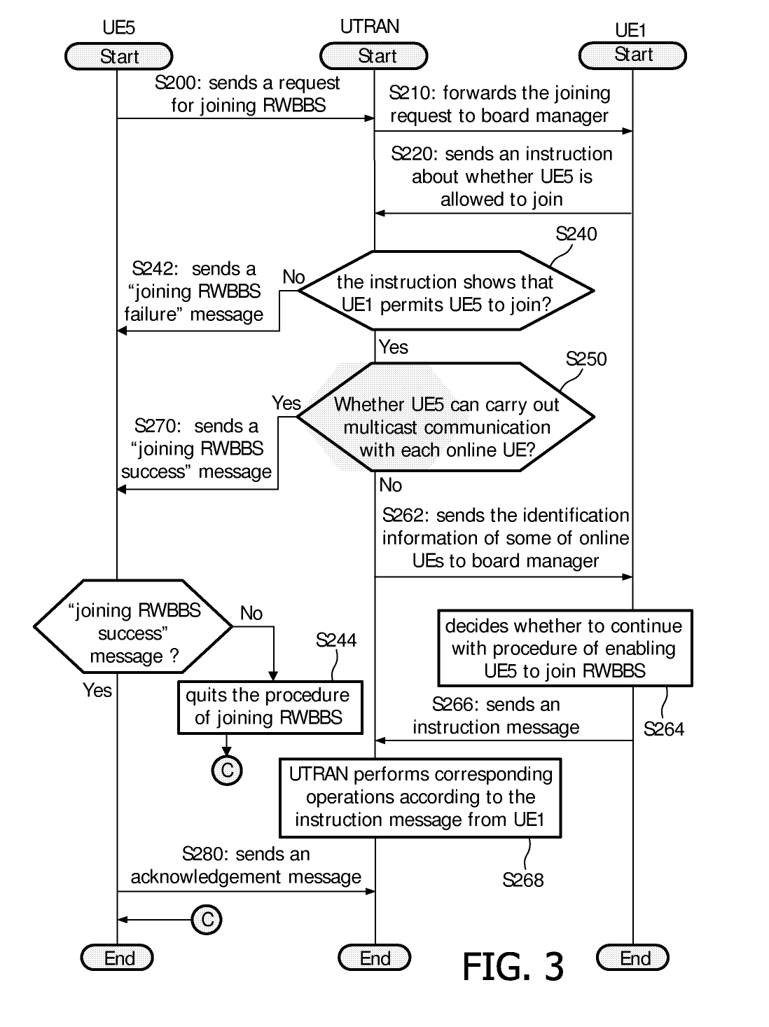

As shown in FIG. 3, when UE5 having P2P communication capability and in idle status attempts to join the RWBBS, UE5 sends a request for joining the RWBBS to UTRAN (step S200).

On receipt of the request for joining the RWBBS, UTRAN forwards the joining request (the joining request also including Identification information of UE5) to the UE responsible for control over the RWBBS, such as UE1, the board manager of the RWBBS in the above embodiment, to inquire whether UE5 is allowed to join the RWBBS or not (step S210).

On receipt of the inquire message, UE1 sends an instruction to UTRAN, to indicate whether or not to accept the joining request of UE5 (step S220).

Based on the instruction received from the board manager UE1, UTRAN judges whether the board manager UE1 allows UE5 to join the RWBBS or not (step S240).

If the instruction shows that the board manager UE1 doesn't allow UE5 to join the RWBBS, UTRAN sends a “joining RWBBS failure” message to UE5 (step S242). On receipt of the “joining RWBBS failure” message, UE5 quits the procedure of joining the RWBBS (step S244).

If the instruction shows that the board manager UE1 allows UE5 to join the RWBBS, UTRAN will check whether UE5 can carry out multicast communication with each current online UE of the RWBBS or not (step S250), i.e.: judge whether the distance between UE5 and each online UE is beyond the wireless coverage range for P2P communication or not and judge whether the direct links between UE5 and each online UE can be used for transferring traffic signals or not respectively (i.e. whether P2P probing succeeds). This procedure can also adopt the specific steps in multicast communication as described in the patent application filed by KONINKLIJKE PHILIPS ELECTRONICS N.V., Attorney's Docket No. CNPHI0087, and detailed description is omitted herein.

If the checking result shows that UE5 can carry out multicast communication with each current online UE of the RWBBS, UTRAN send a “joining RWBBS success” message to UE5, and embeds into the message about the user Identification information of the board manager UE1 responsible for control over the RWBBS, the name of the RWBBS and the Identification information of each current online UE of the RWBBS (step S270). Further, UTRAN also sends to each current online UE of the RWBBS a message that UE5 joins successfully the RWBBS.

On receipt of the “joining RWBBS success” message from UTRAN, UE5 sends an acknowledgement message to UTRAN, to notify the network system that it is ready to exchange information with each online user of the RWBBS (step S280).

If the checking result shows that UE5 can't carry out multicast communication with some current online UEs of the RWBBS, UTRAN sends the Identification information of the some online UEs to the board manager UE1 (step S262).

Based on the Identification information of the some online UEs, UE1 decides whether or not to proceed with the procedure for enabling UE5 to join RWBBS (step S264) and sends its decision as an instruction message to UTRAN (step S266).

Based on the instruction message from UE1, UTRAN performs the corresponding operations (step S268). Specifically, if the instruction message shows that UE1 decides to continue with the joining procedure, UTRAN performs operations similar to step S270 to send a “joining RWBBS success” message to UE5; and UE5 performs operations similar to step S280 to send an acknowledgement message to UTRAN after receiving the “joining RWBBS success” message. If the instruction message shows that UE1 decides to stop performing the joining procedure, UTRAN performs operations similar to step S242 to send a “joining RWBBS failure” message to UE5; and UE5 performs operations similar to step S244 to exit the procedure of joining RWBBS after receiving the “joining RWBBS failure” message.

FIG. 3 illustrates the procedure for a UE to join a RWBBS in accordance with an embodiment of the present invention. The following description is made to a procedure in which an online UE such as UE5 of the RWBBS quits the RWBBS, in conjunction with another embodiment of the present invention.

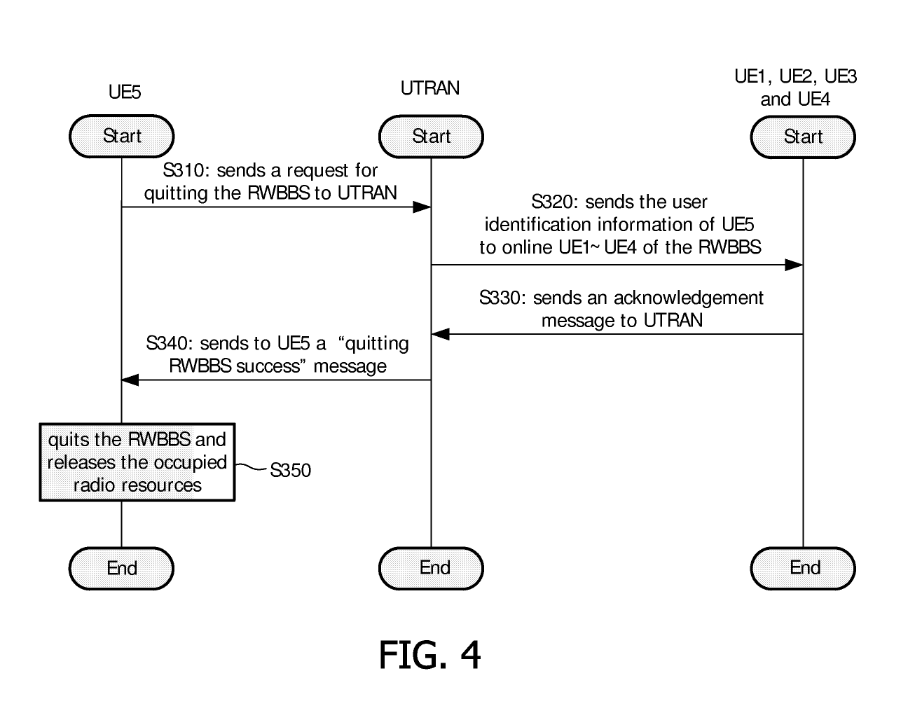

As shown in FIG. 4, when UE5, the online UE of the RWBBS in idle status, attempts to quit the RWBBS, UE5 sends a request for quitting the RWBBS to UTRAN (step S310).

On receipt of the quit request, UTRAN sends the user identification information of UE5 along with the quit request to each current online UE of the RWBBS, such as UE1˜UE4 (step S320).

On receipt of the quit request of UE5, UE1, UE2, UE3 and UE4 send a receipt acknowledgement message to UTRAN respectively, to indicate that they have already be informed that UE5 will quit the RWBBS (step S330).

On receipt of the acknowledgement messages from UE1˜UE4, UTRAN sends to UE5 a “quitting RWBBS success” message (step S340), so that UE5 will quit the RWBBS and release the radio resources occupied on receiving the “quitting RWBBS success” message (step S350).

Detailed descriptions are given above to the RWBBS communication method for use in wireless communication networks as proposed in the present invention, taken in conjunction with FIG. 2 to FIG. 4. But the present invention is not limited to these embodiments. For example, the present invention is not only suitable for establishing RWBBS communication among a group of UEs camping in the same cell, but also applicable to the cases in which multiple UEs are camping in different cells respectively or multiple UEs are outside the coverage range of the cell.

If multiple UEs are camping in different cells respectively, except that control messages need to be forwarded by different base stations, other steps are the same as those in the above embodiments of the present invention. As to the procedure in which control messages are transferred among different base stations, reference can be made to the patent application entitled “Method and apparatus for establishing P2P communication among UEs in different cells”, serial No. CN200310118646.1, filed by KONINKLIJKE PHILIPS ELECTRONICS N.V. on Nov. 27th, 2003, which is incorporated herein by reference. As to the transfer of control messages in case that multiple UEs are outside the coverage range of the cell, reference can be made to the patent application entitled “Billing method and apparatus for offline P2P communication”, serial No. CN200410056540.8, filed by KONINKLIJKE PHILIPS ELECTRONICS N.V. on Aug. 10th, 2004, which is incorporated herein by reference. Other procedures for establishing multicast communication are the same as the present embodiment.

The above communication method capable of providing real-time wireless BBS as proposed in the present invention can be implemented in software or hardware, or in combination of both.

### ADVANTAGES OF THE INVENTION

As stated above, according to the communication method for providing real-time wireless BBS of the present invention, when a group of UEs expecting to exchange information in real time are very close to each other, since the group of UEs can exchange traffic information via the P2P direct links among them with no need to establish dedicated channel for transferring traffic signals between the base station and the UEs, the communication method can help save radio resources effectively, and mitigate wireless interferences and further increase network capacity as well.

Meanwhile, since control link still exists between each UE and UTRAN during RWBBS communication, RWBBS communication mode can be conducted under control and support of UTRAN and UTRAN holds control over the radio resources all through.

Further, with regard to the above communication method for providing real-time wireless BBS of the present invention as described taking TD-SCDMA as an example, it is equally applicable to TDD CDMA systems.

It is to be understood by those skilled in the art that the method and apparatus for providing real-time wireless BBS (RWBBS) as disclosed in this invention can be made of various modifications without departing from the spirit and scope of the invention as defined by the appended claims.

1. A communication method to be executed by a network system, comprising the steps of:
(A) receiving a request for establishing a real-time wireless BBS (Bulletin Board Service) from a UE supporting P2P (Peer-to-Peer) communication mode among a group of UEs (User Equipments), wherein the request includes identification information of other UEs among the group of UEs;
(B) allocating corresponding radio resources to the group of UEs according to the request for establishing the real-time wireless BBS, so that information can be exchanged via direct links among UEs that supporting P2P communication mode.

2. The communication method according to claim 1, wherein step (B) comprises:
(a) determining whether requirements for establishing the real-time wireless BBS among the group of UEs are satisfied or not, according to the request for establishing the real-time wireless BBS;
(b) allocating the radio resources if the requirements for establishing the real-time wireless BBS are satisfied.

3. The communication method according to claim 2, wherein step (a) comprises:
(a1) sending a paging message to the other UEs respectively, according to the request for establishing the real-time wireless BBS;
(a2) receiving paging response messages from the other UEs;
(a3) determining whether the requirements for establishing the real-time wireless BBS among the group of UEs are satisfied or not, according to the paging response messages.

4. The communication method according to claim 3, wherein the paging response messages include P2P capability indication information.

5. The communication method according to claim 4, wherein step (a3) comprises:
judging whether the other UEs have the capability to carry out a real-time wireless BBS communication or not according to the P2P capability indication information, to determine whether the real-time wireless BBS can be established between the group of UEs or not.

6. The communication method according to claim 5, wherein the paging message includes the identification information of the UE, the paging response messages include information about whether or not the other UEs accept the request for establishing the real-time wireless BBS; and the step (a3) further comprises:
judging whether or not the other UEs agree to establish the real-time wireless BBS with the UE according to the paging response messages, to determine whether the real-time wireless BBS can be established among the group of UEs or not.

7. The communication method according to claim 4, wherein the paging response messages include location information of the other UEs; and the step (a3) comprises:
judging whether or not a distance between any two UEs in the group of UEs is within wireless coverage range for P2P communication according to the location information, to determine whether the real-time wireless BBS can be established among the group of UEs or not.

8. The communication method according to claim 2, wherein step (a) comprises:
allocating radio resources for probing the direct links to the group of UEs, so that each UE can send probing signals to other UEs in the group of UEs via the direct links respectively;
receiving probing reports from the each UE;
judging whether or not traffic signals can be transferred via the direct links according to the probing reports, to determine whether the real-time wireless BBS can be established among the group of UEs or not.

9. The communication method according to claim 5, further comprising the steps of:
reporting, if some UEs among the other UEs don't have multicast communication capability or don't agree to establish the real-time wireless BBS, the identification information of the some UEs to the UE that sent the request for establishing the real-time wireless BBS;
receiving an instruction message from the UE that sent the request for establishing the real-time wireless BBS;
determining whether or not to establish the real-time wireless BBS among the group of UEs.

10. The communication method according to claim 7, further comprising the steps of:
reporting, if distances among some UEs among the UEs and other UEs among the ULEs are beyond the wireless coverage range for P2P communication or the probing reports from the some UEs show that some of the direct links probed can't be used for transferring traffic signals, the identification information of the some UEs and the other UEs is reported to the UE that sent the request for establishing the real-time wireless BBS;
receiving an instruction message from the UE that sent the request for establishing the real-time wireless BBS;
determining whether to establish the real-time wireless BBS among the group of UEs according to the instruction message.

11. The communication method according to claim 2, further comprising the steps of:
sending an inquire message to the UE that sent the request for establishing the real-time wireless BBS, to obtain the identification information of a UE responsible for control over the real-time wireless BBS;
receiving a designation instruction from the UE that sent the request for establishing the real-time wireless BBS, the designation instruction including the identification information of the UE responsible for control over the real-time wireless BBS.

12. The communication method according to claim 11, further comprising the steps of:
receiving an instruction for closing the real-time wireless BBS from the UE responsible for control over the real-time wireless BBS;
forwarding the instruction for closing the real-time wireless BBS to online UEs of the real-time wireless BBS;
reclaiming the allocated radio resources.

13. The communication method according to claim 11, further comprising the steps of:
(i) receiving a request for joining the real-time wireless BBS from a UE;
(ii) inquiring the UE responsible for control over the real-time wireless BBS whether to allow the UE to join the real-time wireless BBS or not;
(iii) receiving an instruction from the UE responsible for control over the real-time wireless BBS;
(iv) performing corresponding operations according to the instruction, so as to permit the UE to join the real-time wireless BBS or prohibit the UE from joining the real-time wireless BBS.

14. The communication method according to claim 13, wherein step (iv) comprises:
checking, if the instruction permits the UE to join the real-time wireless BBS, whether or not the UE can carry out multicast communication with online UEs of the real-time wireless BBS;
allocating corresponding radio resources to the UE if requirements for multicast communication are satisfied, so that the UE can communicate via the real-time wireless BBS.

15. The communication method according to claim 2, further comprising the steps of:
receiving a request for quitting the real-time wireless BBS from a UE;
forwarding the request for quitting the real-time wireless BBS to online UEs of the real-time wireless BBS.

16. A communication method to be executed by a UE supporting P2P communication mode, comprising the steps of:
(A) sending a request to a network system for establishing a real-time wireless BBS among a group of UEs including the UE, wherein the request includes identification information of other UEs among the group of UEs;
(B) receiving radio resources allocated according to the request from the network system;
(C) exchanging information with the other UEs via direct links for P2P communication, by using the radio resources.

17. The communication method according to claim 16, further comprising the steps of:
receiving a report from the network system;
determining whether the real-time wireless BBS can be established between the group of UEs or not according to the report, which comprises information that the some UEs among the other UEs don't have capabilities to carry out the real-time wireless BBS;
sending the determination result as an instruction message to the network system.

18. The communication method according to claim 17, wherein the report further includes information that a distance between some UEs among the UEs and other UEs among the UEs is beyond wireless coverage area for P2P communication, and/or information about that probing reports of some UEs among the UEs show that some of the direct links probed can't be used for transferring traffic signals.

19. The communication method according to claim 18, further comprising the steps of:
receiving an inquire message from the network system;
choosing a UE among the group of ULEs to be responsible for control over the real-time wireless BBS, according to the inquire message;
sending the identification information of the chosen UE to the network system.

20. A communication method for a wireless communication network supporting P2P communication mode to be executed by a UE, comprising the steps of:
receiving a paging message, which is sent out according to a request for establishing a real-time wireless BBS among a group of UEs, from a network system;
sending a paging response message to the network system, wherein the paging response message comprises at least one of location information of the UE, P2P capability indication information and information about whether establishment of the real-time wireless BBS is allowed.

21. The communication method according to claim 20, further comprising the steps of:
receiving radio resources allocated for probing direct links from the network system;
sending probing signals to other UEs among the group of UEs via the direct links, by using the radio resources;
communicating via the direct links in real-time wireless BBS mode if the probing succeeds.

22. The communication method according to claim 21, further comprising the steps of:
sending a request for joining the real-time wireless BBS to the network system;
receiving a message about successfully joining the real-time wireless BBS from the network system;
obtaining the identification information of the UE responsible for control over the real-time wireless BBS and online UEs of the real-time wireless BBS, according to the joining success message.

23. The communication method according to claim 21, further comprising the steps of:
sending a request for quitting the real-time wireless BBS to the network system;
releasing the radio resources to quit the real-time wireless BBS.

24. The communication method according to claim 21, further comprising the steps of:
receiving a designation instruction from the network system, to be responsible for control over the real-time wireless BBS;
sending to the network system an instruction to close the real-time wireless BBS;
releasing the radio resources.

25. The communication method according to claim 24, further comprising the steps of:
receiving a message about a UE attempting to join the real-time wireless BBS from the network system;
sending to the network system an instruction for permitting or prohibiting the UE to join the real-time wireless BBS.

26. A network system, comprising:
a receiving unit, for receiving a request for establishing a real-time wireless BBS from a UE supporting P2P communication mode among a group of UEs, wherein the request includes identification information of other UEs among the group of UEs;
a determining unit, for determining whether requirements for establishing the real-time wireless BBS among the group of UEs are satisfied or not;
an allocating unit, for allocating corresponding radio resources to the group of UEs if the requirements for establishing the real-time wireless BBS are satisfied, so that information can be exchanged via direct links between UEs supporting P2P communication mode among the group of UEs.

27. The network system according to claim 26, further comprising:
a transmitting unit, for sending a paging message to the other UEs respectively, according to the request for establishing the real-time wireless BBS;
the receiving unit, for receiving paging response messages from the other UEs, wherein the paging response messages include P2P capability indication information;
the determining unit, for judging whether the other UEs have the capability to carry out real-time wireless BBS communication or not according to the P2P capability indication information, to determine whether the real-time wireless BBS can be established among the group of UEs or not.

28. The network system according to claim 27, wherein the paging response messages include location information of the other UEs, and the determining unit judges whether or not a distance between any two UEs in the group of UEs is within wireless coverage range for P2P communication according to the location information, to determine whether the real-time wireless BBS can be established among the group of UEs or not.

29. The network system according to claim 26, wherein:
the allocating unit allocates radio resources for probing the direct links to the group of UEs, so that each UE sends probing signals to other UEs in the group of UEs via the direct link respectively;
the receiving unit receives probing reports from the each UE;
the determining unit judges whether or not traffic signals can be transferred via the direct links according to the probing reports, to determine whether the real-time wireless BBS can be established between the group of UEs or not.

30. A UE supporting P2P (Peer-to-Peer) communication mode, comprising:
a transmitting unit, for sending a request to a network system for establishing a real-time wireless BBS among a group of UEs including the UE, wherein the request includes identification information of other UEs among the group of ULEs;
a receiving unit, for receiving radio resources allocated according to the request from the network system;
a communicating unit, for exchanging information with the other UEs via the direct links for P2P communication, by using the radio resources.

31. The UE according to claim 30, further comprising:
a receiving unit, for receiving a paging message sent according to a request for establishing a real-time wireless BBS between a group of UEs from a network system;
the transmitting unit, for sending a paging response message to the network system, wherein the paging response message includes at least one of location information of the UE, P2P capability indication information and information about whether establishment of the real-time wireless BBS is allowed.

32. The UE according to claim 31, wherein:
the transmitting unit sends a request for joining the real-time wireless BBS to the network system;
the receiving unit receives a message about successfully joining the real-time wireless BBS from the network system and obtains the identification information of a UE responsible for control over the real-time wireless BBS and online UEs of the real-time wireless BBS.

33. The UE according to claim 31, wherein the transmitting unit sends a request for quitting the real-time wireless BBS to the network system; and the UE further comprises:
a releasing unit, for releasing the radio resources to quit the real-time wireless BBS.

34. The UE according to claim 31, wherein,
the receiving unit receives a designation instruction from the network system, to be responsible for control over the real-time wireless BBS;
the transmitting unit sends an instruction for closing the real-time wireless BBS to the network system.
